(19) United States
(12) Patent Application Publication
(10) Pub. No.: US 2003/0069815 A1
(43) Pub. Date: Apr. 10, 2003

(54) RFID time tracking

(75) Inventors: Peter M. Eisenberg, Minneapolis, MN (US); Mitchell B. Grunes, Minneapolis, MN (US); Gerald L. Karel, Maplewood, MN (US); John M. Kruse, Minneapolis, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 09/974,321

(22) Filed: Oct. 10, 2001

(51) Int. Cl. G06F 17/60

(52) U.S. Cl. 705/32

(57) ABSTRACT

An improved method of keeping track of time is provided, and specifically an improved method of tracking the amount of time spent by an individual working on a project. The person scans an RFID tag associated with a file using an RFID reader, and a software program begins counting time and associating it with the matter with which the file is related. When the person scans the RFID tag again, the time is stopped, and the elapsed time is billed to a client in regard to the matter associated with the file.

### TECHNICAL FIELD

The present invention relates to an improved method of recording time, and specifically of recording time for a person whose services are billed based on a period of time.

### BACKGROUND OF THE INVENTION

People in several professions bill clients for their services based on the amount of time spent working on a specific project. For example, attorneys often bill clients by the hour, as do accountants and others. Most people either use a notepad to record the amount of time spent on a matter, or a software program that enables the user to select or enter the client, the matter, and the amount of time spent on the project. This practice is bothersome to those who have to do it, and any improvement in such a time recording system would be welcome.

### SUMMARY OF THE INVENTION

An improved method of keeping track of time is provided, and specifically an improved method of tracking the amount of time spent by an individual working on a project. The person scans an RFID tag associated with a file using an RFID reader, and a software program begins counting time and associating it with the matter with which the file is related. When the person scans the RFID tag again, the time is stopped, and the elapsed time is billed to a client in regard to the matter associated with the file. The file may be a standard file for papers, or may be an electronic file stored on a data storage device with which the RFID tag is associated. This time tracking feature may be used to bill clients, to allocate costs internally within an organization or a set of organizations, or in connection with productivity studies. Included within the scope of the invention are a software program for carrying out the methods of the present invention, a computer that runs such a program, and a bill (which may be an electronic bill) that charges a client for services rendered during one or more time periods that were tracked.

### DETAILED DESCRIPTION OF THE INVENTION

In general terms, the present invention provides a better method of keeping track of a period of time, and in one embodiment the period of time is associated with a particular matter or project. In one embodiment, each file containing papers or other materials with which an individual will be working is provided with a radio frequency identification (RFID) tag. The RFID tag may be a passive tag (which does not have a battery) or an active tag (which does have a battery), and, in either case, normally includes an antenna connected to an integrated circuit, or IC. The integrated circuit includes memory, which may be read-write or read-only memory. For example, the IC may be programmed at the factory or subsequently with certain fixed information that is not intended to be altered, such as a serial or other identification number. The IC may also include user-programmable information, so that the RFID tag includes customized information such as information describing a particular object to which the RFID tag is attached, or project to which it relates. The IC may even have memory that can be overwritten with new information so that, for example, information can be updated and thus remain current, or the tags can be reused for another file or project. RFID tags of the general type described above are currently available from a number of sources worldwide, including from Texas Instruments of Dallas, Tex., and have been described in numerous patents and other publications.

Radio frequency identification devices (commonly referred to as “readers” because they read information from an RFID tag, though they may also be capable of writing information to a tag) are also currently available from a number of companies, such as Texas Instruments, and have been described in a variety of patents and other publications. RFID readers are able to transmit signals to RFID tags, and then to obtain information from the RFID tags based on well-known principles. RFID readers can be portable, stationary, connectable to a docking station or other data transfer system, and any or all of them can be used in conjunction with the present invention.

RFID tags can be useful for tracking articles of various types, such as library books and other materials. Applications of this type have been described in, for example, PCT Publication Numbers WO 00/10122 and WO 00/10144, the contents of both of which are incorporated by reference herein. In one particularly useful embodiment, an RFID element may be used together with a magnetic security element to provide both information and security features for the object bearing the combination tag. Combination tags of this type are described in U.S. Pat. No. 6,154,137, the contents of which is also incorporated by reference herein.

Information related to an RFID tag and the object with which it is associated is typically maintained in a database in memory associated with a computer. The computer may be portable (as with a palm-sized computer such as a Palm handheld or a TRGPro, or a notebook computer), or may be a standard desktop computer, or any other computer system configuration. That database may associate, for example, the RFID tag identifier stored in the memory of the tag IC with various pieces of information related to an item to which the tag is attached, such as its name or title, a file or other reference number, a location, a client or customer name, project name, number, or description, summary of previous work done on that matter, or the like. Information that is to be stored on the RFID tag may be obtained from an existing list or database, such as a list of files currently stored in a file room, or currently in use in an office. That list may be one used for inventory purposes, such as bar-code based checkout systems. Using the existing database, or a newly created database, an RFID tag may be programmed by a conversion station with the desired information related to each file. Information to be stored on the RFID tag may also be obtained from an existing database and modified, if appropriate, and then stored on the tag using, for example, a file or data management program.

The use of RFID tags on documents or files, or both, has been described elsewhere, including in U.S. patent application Ser. No. 09/874749, filed Jun. 5, 2001, and entitled “Radio Frequency Identification in Document Management.” RFID tags and readers can be used in such systems to determine whether files are stored in the proper order, or in the proper location, or whether files on a list of lost or otherwise wanted files are present in a certain location. These and other functions may be performed by using the RFID reader to interrogate any tags within the “read range” or interrogation range of the reader. The information obtained from the RFID tag, such as the tag serial number or identifier may be used to obtain additional information about the item from a database stored on the RFID reader, a local computer, a networked or central computer, or more than one of the foregoing.

The method of the present invention uses the same type(s) of RFID tags on the same type(s) of files or documents, but for a much different purpose than those just described. In its most general sense, the RFID-tagged file is used to help an individual record a period of time related to a particular matter. For example, an attorney could use an RFID-tagged file to record how much time she spends on a particular matter for a client. An automotive repair shop could use RFID-tagged files to track how much time a mechanic spends on a particular job. A doctor could use RFID-tagged files to determine how much time she spends with each patient. The time-keeping information can be used for billing purposes, or for productivity studies, or for other reasons such as submissions to a third party, such as an insurer. The time tracking feature may be useful for external purposes (such as billing clients), or for internal purposes (such as allocating costs within an organization).

To implement the systems and methods of the present invention, individual files are provided with RFID tags that are associated (typically in a database) with each respective file. Although standard files for papers are the subject of a preferred embodiment of the invention, electronic files stored on a data storage device, for which the RFID tag is associated with the data storage device, may also be used. That is, if a user works with data storage devices that store electronic files, such as floppy discs, CD-ROMs, flash memory cards, those devices could be tagged with an RFID tag and used with the methods of the present invention in addition to or instead of standard files. An RFID-tagged data storage device of the type described just above is disclosed in EP 944,085, entitled “Two Axis Reading of Memory Chip in Cartridge,” the contents of which is incorporated by reference herein. Accordingly, the term “file” as used in regard to the present invention means both paper and electronic information files that relate to a project on which at least one person is expected to work. As noted above, the RFID tag may include any desired amount or type of information, ranging from only an RFID-tag serial number or identifier, to a client or customer name, project name, number, or description, summary of previous work done on that matter, or the like. That and other information may also or instead be maintained on a database, as described above. If multiple files relate to the same matter, then they can each have an identical RFID tag, or one “master” file can have an RFID tag containing some kinds of information (perhaps including the number of other related files, their serial numbers or identifiers, and/or their descriptions), and the related files can each have RFID tags with some or all of the same information. For example, a master client file may include an RFID tag indicating that it is serial number 122296, that it is one of 10 total files, that the other files have RFID tags with serial numbers 122297 through 122305, that the first three of those files are stored and should remain together, and the like.

Once files have been tagged with RFID tags, they can be interrogated, or written to, by an RFID reader. Those readers are preferably located near a work location, such as a computer workstation, and may be designed to launch and/or enter information into a timekeeping software program that stores information of interest. In one embodiment, each computer workstation includes an RFID reader, and when a user scans the RFID tag, the timekeeping software program assumes that a certain user associated with that workstation is beginning work on the file associated with that RFID tag. The first interrogation of the RFID tag may begin the measurement of the period of time immediately (simultaneously with the interrogation), or may begin it at some subsequent time (5 minutes after interrogation, for example).

When the user has finished or has otherwise stopped working on that matter, then the user scans the RFID tag, and that causes the timekeeping software program to stop counting the time associated with that matter. Alternatively, one scan may cause the software to store a first date and time (and perhaps other information), and a subsequent scan may cause the software to store a second date and time, so that comparison of one with the other yields the total elapsed time. Another way to stop the time associated with one matter could be simply to interrogate an RFID tag on a file associated with another matter, which would stop or at least suspend the time period associated with the first matter. If that is done, then when the file associated with the second matter is interrogated a second time, the time period associated with that matter could end, and the time period attributable to the first matter could optionally begin again. Successive entries in the timekeeping system may resemble the following:

| | |
|---|---|
| First scan: | Attorney Byron White begins work |
| (starts time on first | Beginning time: 7:06 a.m. |
| project) | Date: Oct. 7, 2001 |
| | Client: 3M Company |
| | Project: Donation of parkland |
| Second scan: | Attorney Byron White begins work |
| (ends time on first | Beginning time: 8:15 a.m. |
| project; | Date: Oct. 7, 2001 |
| starts time on second | Client: U.S. Dept. of Justice |
| project) | Project: Classified |
| Third scan: | Attorney Byron White ends work |
| (ends time on second | Ending time: 9:45 a.m. |
| project; | Date: Oct. 7, 2001 |
| re-starts time on first | Client: U.S. Dept. of Justice |
| project) | Project: Classified |
| Fourth scan: | Attorney Byron White ends work |
| (ends time on first | Ending time: 12:45 p.m. |
| project) | Date: Oct. 7, 2001 |
| | Client: 3M Company |
| | Project: Donation of parkland |
| Fifth scan: | Attorney Byron White begins work |
| (starts time on third | Beginning time: 1:25 p.m. |
| project) | Date: Oct. 7, 2001 |
| | Client: 3M Innovative |
| | Properties Company |
| | Project: Supreme Court appeal - patents |
| Sixth scan: | Attorney Byron White ends work |
| (ends time on third | Ending time: 7:45 p.m. |
| project) | Date: Oct. 7, 2001 |
| | Client: 3 M Innovative Properties |
| | Company |
| | Project: Supreme Court appeal - patents |

This and other information can easily be provided to and output by the timekeeping software system. Data could also be added to the timekeeping system through a user interface associated with a computer, so that a more exact definition of the work done could be provided, or the user identification correlated to a workstation could be changed (if a new user were using a workstation normally used by someone else), billable time and associated fees and costs related to collateral matters could be correlated to the work done (such as telephone conferences and charges, copier charges, research fees, parts, or the like). These and other activities described herein could also be associated with different individuals by, for example, interrogating an RFID-tagged badge or by selecting or entering the person's name into a software user interface.

Similarly, a separate RFID tag could be scanned to indicate a particular task that is to be associated with a person and a client, or matter, or both. For example, a person could have RFID tags associated with litigation, document review, agreement drafting, patent application drafting, and other such tasks, and simply interrogate one or more of those RFID tags along with a file tag to begin tracking time. Accordingly, the timekeeping method of the present invention may be a supplement to, and not a complete replacement for, entering data into a timekeeping software program. In another embodiment, an employee badge or pass can also be scanned before or after scanning an RFID-tagged file, so that the user is identified and correlated to the file. In yet another embodiment, time may be tracked by the class or type of service provider without specifically identifying the person providing the service. For example, time may be tracked in a legal office for attorneys, paralegals, support staff, and others; in a medical office for doctors, nurses, support staff, and others; in a repair shop for mechanics or repair technicians, office staff, and others; and in other similar ways. In any of the embodiments herein, time may be tracked in days, hours, and minutes, or may be tracked in other designated increments such as tenths of an hour, quarters of an hour, or the like.

In another embodiment of the invention, a signal may be created to notify the user of a certain condition related to a file or matter on which the user has been working. For example, if a client has a rule that it will not pay for more than 9.5 billable hours in a single day for a particular individual, then a computer could create and transmit an electronic message, an audio signal, a visual signal, or a combination of these or other signals when 9.5 billable hours have been reached by that individual. As another example, if work were being done on a matter in which a price quotation had been provided to a client for that specific project, then signals could be provided to the user before, at, and/or after the cost allocated to that project had been reached (based on the elapsed time). This would notify the user that the allocated time was about to expire, that it had expired, and that additional time beyond the allocated amount of time was being used, respectively. The user may also wish to receive a signal when a designated amount or percentage of time had passed (50%, for example), to enable the user to gauge whether she is working at more or less than the minimum appropriate pace. The user interface could also enable the user to provide additional information related to the matter in question, or to edit or delete existing information, perhaps in response to the signal. In that manner, the user could enter information indicating that additional time had been approved for the project, or a revised budget accepted, for example. The user could be signaled again if and when any extended time period or limit is approaching, or was reached, or had past, in the manner described above.

The benefits of a time recording system such as the one described herein are numerous and substantial. Users can simply scan an RFID tag when beginning and ending work on a project by using files that the user may already be using, and in that manner can have a highly accurate record of the time actually spent on the matter. Time spent on breaks, meal times, or conferences on other matters can be properly excluded from time billed to a client, which can enhance the client's trust in the person and organization billing the time. Also, RFID tags may be provided on files for file tracking and record keeping purposes, and the addition of the method and system of the present invention can be an added benefit unavailable in systems that solely track assets. Lastly, the system of the present invention can enable an organization to achieve almost real-time billing, because the system does not need to wait for users to enter their time into a software program at the end of a day, a week, or even a month. To provide a security feature, RFID and/or magnetic electronic article surveillance markers may be used so that files or materials that are not supposed to leave a protected area would set off an alarm if removed from that area without authorization, as is known in the art.

In its broadest respect, one method according to the present invention simply relates to beginning the measurement of a time period when an RFID tag is interrogated. In many cases, it is also desirable to end the time period when the RFID tag is interrogated again, but the time period could be ended by other methods, such as automatically after a defined period of time (1 hour, or 1 day, for example), or by entering instructions through a keyboard, touch-panel display, bar code, or other user interface. Bills may also be generated using time periods measured as described herein, and the bills may be available electronically (over the internet, or on an intranet, for example), and/or sent electronically to a client for payment.

The time tracking methods of the present invention may also be used as part of a data gathering step in productivity studies. For example, businesses often wish to track how long a particular matter takes from inception to resolution, and may wish to reduce that cycle time to decreases costs. The methods described herein would be useful in tracking time during some part or all of that process if, for example, when a matter were initiated a file were created and a date and time were recorded, and when the matter was concluded (or when a step within the process was completed) another date and time were recorded. This information could be used to determine the cycle time for parts or all of the process, the amount of time during which no work was being done, the number of times different people worked on the matter, and other useful information.

In an additional embodiment of the invention, the amount of time that a file is at a specified location may be tracked, and that information used as described above to determine cycle time or backlog of work, for example. For example, an RFID reader could interrogate an RFID tag on a file that was placed in a specified location, such as a shelf, cabinet, or desk, and then a software program could calculate how long that file remained in that location before the time period ended (by a second RFID interrogation, or by another method as described herein).

In a final embodiment of the invention, although the invention has been described as including at least the starting of a particular period of time, RFID interrogation could be used only to end a period of time that was started in a manner other than by RFID interrogation. For example, if a time period were measured beginning when a file number was assigned, it could be ended the first time the RFID tag was interrogated. Thus, RFID interrogation may be used to start, end, or start and end the measurement of a period of time.

These and other aspects of the present invention are more fully set out in the claims that follow.

We claim:

1. A method of recording time associated with a project, comprising the steps of:
(a) providing at least one file with an RFID tag that can provide identification information when interrogated by an RFID reader; and
(b) interrogating the RFID tag using an RFID reader to begin the measurement of a period of time.

2. The method of claim 1, further comprising the step of:
(c) interrogating the RFID tag a second time to end the measurement of the period of time.

3. The method of claim 1, wherein step (b) comprises recording a first date and time.

4. The method of claim 2, wherein step (c) comprises recording a second date and time.

5. The method of claim 4, wherein the period of time is determined by comparing the first date and time with the second date and time.

6. The method of claim 1, further comprising the step of:
(c) ending the measurement of the period of time responsive to a command entered by a user into a user interface associated with a computer.

7. The method of claim 1, wherein the measurement of the period of time begins substantially simultaneous with the interrogation.

8. The method of claim 1, wherein the measurement of the period of time begins subsequent to the interrogation.

9. The method of claim 1, wherein the file is a file for papers.

10. The method of claim 1, wherein the file is an electronic file, and the data storage device on which the electronic file is stored is provided with the RFID tag.

11. The method of claim 1, further comprising the step of:
(c) ending the period of time after a predetermined amount of time.

12. The method of claim 1, further comprising the step of:
(c) ending the period of time when a user enters a command into a computer.

13. The method of claim 1, further comprising the step of:
(c) providing a signal to a user prior to having measured a predetermined period of time.

14. The method of claim 1, further comprising the step of:
(c) providing a signal to a user when a predetermined period of time has been measured.

15. The method of claim 1, further comprising the step of:
(c) providing a signal to a user after a predetermined period of time has been measured.

16. The method of claim 1, wherein the identification information is associated in a database with a project.

17. The method of claim 1, wherein the identification information is associated in a database with a client.

18. The method of claim 1, wherein the identification information is associated in a database with both a client and a project.

19. The method of claim 1, wherein the identification information is associated in a database with a named person who provides a service.

20. The method of claim 1, wherein the identification information is associated in a database with a class of persons who provide a service.

21. The method of claim 1, wherein step (b) is done using a software program, and a user can provide additional information related to a project to the software program using a computer.

22. The method of claim 21, wherein the additional information includes information identifying a task.

23. The method of claim 22, wherein the additional information is provided by interrogating an RFID tag associated with the task.

24. The method of claim 21, wherein the additional information includes information identifying a person.

25. The method of claim 24, wherein the additional information is provided by interrogating an RFID tag associated with the person.

26. The method of one of claims 1 through 25, wherein the period of time is used in connection with billing a client for that period of time.

27. The method of claim 1, wherein the period of time is used in connection with an allocation of costs.

28. The method of claim 1, wherein the period of time is used in connection with a productivity study.

29. The method of claim 1, wherein the period of time is used to determine how long a file was positioned at a predetermined location.

30. A method of recording time spent by a service provider on a project, comprising the steps of:
(a) providing at least one file with an RFID tag that can provide identification information when interrogated by an RFID reader;
(b) interrogating the RFID tag using an RFID reader to begin the measurement of a period of time;
(c) ending the time period; and
(d) billing a client for work done during that period of time.

31. The method of claim 30, wherein step (c) comprises ending the time period by interrogating the RFID-tagged file a second time.

32. The method of claim 30, wherein the file is a file for papers.

33. The method of claim 30, wherein the file is an electronic file, and the data storage device on which the electronic file is stored is provided with the RFID tag.

34. A computer software program, wherein the software is adapted to receive a signal from an RFID reader, including an RFID tag identifier, associate that identifier with an entry on a database, begin measuring a period of time when the signal is received, and associate the period of time with the entry on the database.

35. The software program of claim 34, wherein the software begins to measure a period of time by storing a first date and time.

36. The software program of claim 34, wherein the software is further adapted to receive a second signal from an RFID reader, and end the measurement of the period of time when the second signal is received.

37. The software program of claim 34, wherein the software is further adapted to end the measurement of the period of time upon receipt of a command entered into a computer by a user.

38. The software program of claim 34, wherein the software is a portion of a software-based billing system.

39. The software program of any one of claims 34 through 38, in combination with a computer that executes the software program.

40. A computerized timekeeping system, comprising:
(a) a computer including a database;
(b) an RFID interrogator;
(c) at least one file that is associated with at least one RFID tag; and
(d) software operated by the computer that is adapted to begin measuring a period of time upon the interrogation of an RFID-tagged file by the RFID interrogator.

41. The system of claim 40, wherein the system comprises multiple files and multiple RFID interrogators.

42. The system of claim 41, wherein at least one of the RFID interrogators is portable.

43. The system of claim 40, wherein a user can enter information into the computer to identify at least one of the user, a client, and information about a project.

44. A bill for time spent on a project, wherein the bill is computer-generated using at least one time period measured by interrogating an RFID tag.

45. The bill of claim 44, wherein the at least one time period is measured between a first interrogation of an RFID tag and a second interrogation of an RFID tag.

46. The bill of claim 45, wherein the first and second interrogations are of the same RFID tag.

47. The bill of claim 44, wherein the bill is available electronically.

48. The bill of claim 47, wherein the bill is transferred electronically to a client for payment.

49. A method of recording time associated with a project, comprising the steps of:
(a) providing at least one file with an RFID tag that can provide identification information when interrogated by an RFID reader; and
(b) beginning the measurement of a period of time; and
(c) interrogating the RFID tag to end the measurement of the period of time.

50. The method of claim 49, wherein step (b) comprises beginning the measurement of a period of time without interrogating the RFID tag.
